(19) United States
(12) Patent Application Publication
(10) Pub. No.: US 2015/0291173 A1
(43) Pub. Date: Oct. 15, 2015

(54) SYSTEM FOR COMBINING THE CLUTCH PEDAL AND THE ACCELERATION PEDAL OF A CAR

(71) Applicant: Mahmoud MOHAMED SAID, Paris (FR)

(72) Inventor: Mahmoud MOHAMED SAID, Paris (FR)

(21) Appl. No.: 14/435,705

(22) PCT Filed: Sep. 12, 2013
(86) PCT No.: PCT/FR2013/000238

§ 371 Date: Jun. 29, 2015

(30) Foreign Application Priority Data
Oct. 23, 2012 (FR) 1202816

(51) Int. Cl. B60W 30/18; B60W 10/04; B60W 10/02

(52) U.S. Cl. CPC B60W 30/18181; B60W 10/02; B60W 10/04

(57) ABSTRACT

The invention relates to a device for removing the clutch pedal while keeping the clutch system that will work with a new pedal produce the acceleration and the clutch at the same time

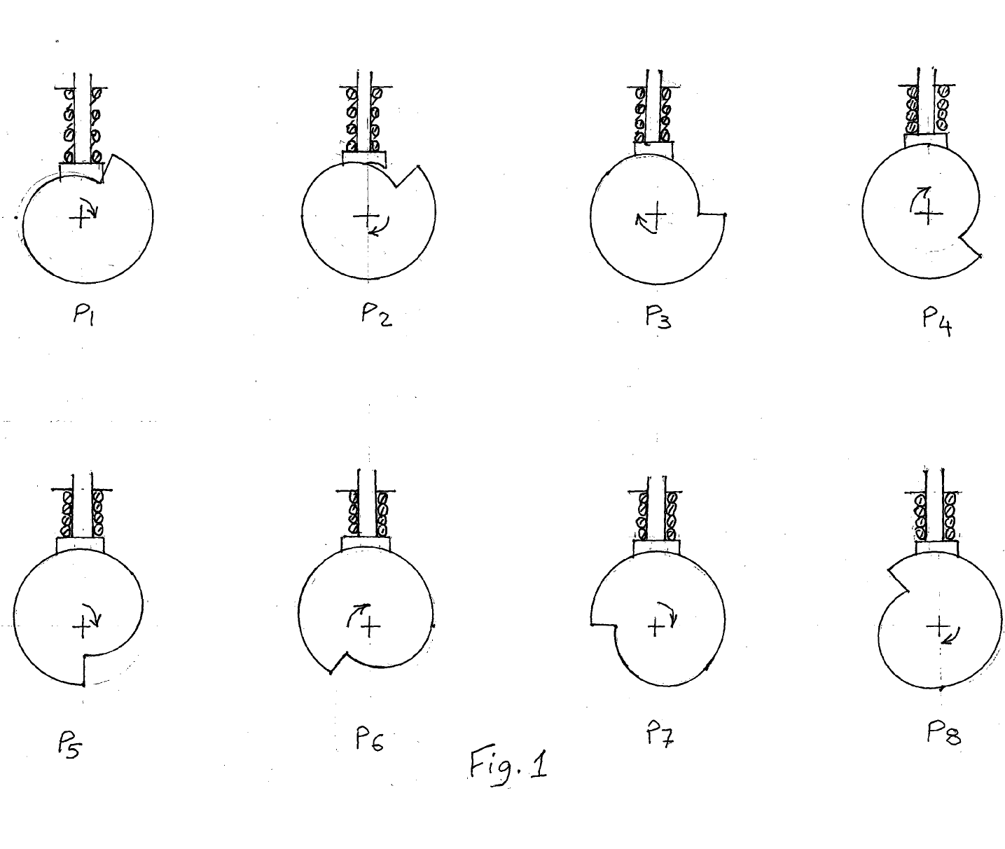

It consists of a single pedal which accelerates the car and simultaneously rotates a cam FIG. 1 for connecting and disconnecting the clutch disc

The device according to the invention is intended for cars

This innovation combines the function of the clutch pedal and the accelerator pedal by a single pedal (pedal new) for 2 functions, and deleting the car clutch pedal

Take care of the clutch pedal, the brake pedal and the accelerator pedal at the same time is difficult for some people: also manipulate and manage two pedals is easier than manipulating and managing three pedals.

The goal of innovation is to cancel the clutch pedal, and keep the clutch system itself.

Actually at a standstill, the clutch disc in the car is permanently connected and we must at first to press the clutch pedal to engage first gear.

With this innovation disc clutch is disconnected permanently by a spring or other mechanical or hydraulic means, unlike the actual situation. The movement of the clutch pedal and the movement of the accelerator pedal are always in the opposite direction and the two movements are never at the same direction.

We can be able to produce a new pedal which makes a movement and other movement in against direction, this means make the current movement of the clutch pedal and accelerator pedal at the same time.

According to this innovation, the beginning of the pressure on the new pedal will cause the beginning of the connection of the clutch disc and the total connection will be entirely at the end of the first third of the way of the pedal (clutch and acceleration) and the clutch disk is remaining in connection 100% during the last ⅔ distance of the new pedal.

At the beginning of the movement of lifting the foot of the new pedal, the clutch will remain in connection to 100% for the ⅔ OF PATH, and the separation of the clutch disc will start at the beginning of the last third of path of the new pedal and disconnection will be 100% at the end of the last third of path.

According to this invention we can start engaging the 1^{st} gear without need to press any pedal.

The pressure on the new pedal (clutch+acceleration) will accelerate the engine and in the opposite direction will connect the clutch disc at the same time, lifting the foot of the new pedal will be equal to the double action (pressing the clutch pedal and lifting the foot off the accelerator pedal) in the current system, and vice versa.

To change the speed of the car or brake the car, we remove the foot from the new pedal: this action will disconnect the clutch, so we can change the speed or stop the car safely.

Under the actual system, if we need to change the speed or slow the car, we must share 2 pedals (take the foot off the accelerator pedal and press the clutch pedal). These two actions are executed at the same time by removing the foot from new pedal.

Now at the beginning of the steering, it must first press the clutch pedal, but with this innovation, the clutch is in the case of permanent separation and we can directly engage the first gear, then start the new press pedal to accelerate, begging the connection of the disc with the rotation of the motor gradually, and the pressure is still on the new pedal to accelerate, the connection will be 100% to about + or −1500 RPM, at the end of the 1^{st} third of the path of the new pedal.

With a gradual pressure on the new pedal to accelerate, the connection of the clutch disc will remain 100% during last ⅔ of path.

After accelerating to 100% and when the foot leave the new pedal and during the 67% of the path, the clutch disc will remain connected to 100% and from the beginning of last third, the disconnection begins and disconnection arrive at 100% at the end of the path.

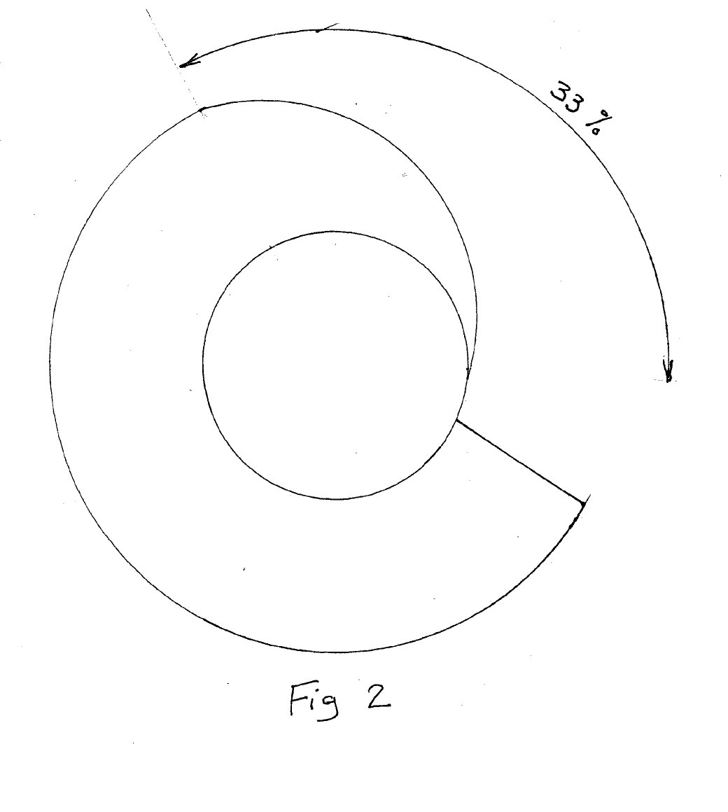

The application of motion connecting and disconnecting clutch is achievable by a simple device cam FIG. 2

8 positions of the cam are in FIG. 1

1 is the clutch cable pulled by the spring (2) 100% disconnection position 1 (off car)

Position (1) Disconnect the clutch disc with 0% pressure on the new pedal

Position (2) 33% connection of the clutch disc with 10% pressure on the new pedal

Position (3) 67% connection of the clutch disc with 20% pressure on the new pedal

Position (4) 100% connection of the clutch disc with 33% pressure on the new pedal

Position (5) 100% connection of the clutch disc with 50% pressure on the new pedal

Position (6) 100% connection of the clutch disc with 70% pressing the new Pedal

Position (7) 100% connection of the clutch disc with 85% pressing the new Pedal

Position (8) 100% connection of the clutch disc with 100% pressure on the new pedal

1. An invention for combining the clutch pedal and the accelerator pedal for the car in one new pedal characterized in that the new pedal is accelerating and clutch at the same time by a cam device FIG. 2.

2. The invention of claim 1, characterized in that the clutch position in disconnected all the time with the car stop (standby mode) and the connection begins when we strait to press the pedal to accelerate with new pedal simultaneously.

3. According to claim 1 characterized in that at the 1st third path of the new pedal produce 100% of clutch connection, and the connection staying 100% until the end of the path.

4. According to claim 1 characterized in that one new pedal is sufficient to operate in place of 2 actuals pedals (clutch and acceleration) in the existing pedal system now.

5. The device according to the invention to brake the car with pressing the brake pedal after we lift the foot off the new pedal without further need to press any other pedal.

6. A device according to the invention to engage any speed with manual gearbox directly without the need for pressing another pedal.

7. A device in accordance with claim 1 wherein the connection and disconnection of the clutch disc with a cam FIG. 1 and FIG. 2 linked with the new pedal.

8. A device in accordance with claim 1 wherein a spring FIG. 1 (or other hydraulic means) takes the clutch cable permanently (disconnected position) in standby case.
